(19) United States
(12) Patent Application Publication
(10) Pub. No.: US 2026/0214465 A1
(43) Pub. Date: Jul. 23, 2026

(54) SYSTEMS AND METHODS FOR PROVIDING BEST FIT FEEDBACK FOR PREDICTIONS FROM MULTIPLE MACHINE LEARNING MODELS

(71) Applicant: Verizon Patent and Licensing Inc., Basking Ridge, NJ (US)

(72) Inventors: Suzann HUA, Beverly Hills, CA (US); Chien-Yuan HUANG, Basking Ridge, NJ (US); Ye HUANG, San Ramon, CA (US); Tony FERREIRA, Greenwich, CT (US)

(73) Assignee: Verizon Patent and Licensing Inc., Basking Ridge, NJ (US)

(21) Appl. No.: 19/030,442

(22) Filed: Jan. 17, 2025

(51) Int. Cl. H04W 24/02; H04L 41/149

(52) U.S. Cl. CPC H04W 24/02; H04L 41/149

(57) ABSTRACT

A device may receive, from a consumer network function (NF), a prediction request that includes an analytics identifier and an indication of best fit feedback support by the consumer NF, and may generate multiple predictions for the analytics identifier using multiple machine learning models. The device may provide the multiple predictions to the consumer NF, and may receive, from the consumer NF, multiple best fit scores corresponding to the multiple predictions. The device may store the multiple best fit scores for the analytics identifier, and may update a selection process of the multiple machine learning models for future predictions based on the multiple best fit scores.

### BACKGROUND

In telecommunications, particularly within the context of fifth-generation (5G) mobile networks, machine learning models are increasingly instrumental in forecasting network conditions and optimizing network performance.

### BRIEF DESCRIPTION OF THE DRAWINGS

FIGS. 1A-1F are diagrams of an example associated with providing best fit feedback for predictions from multiple machine learning models.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for providing best fit feedback for predictions from multiple machine learning models.

### DETAILED DESCRIPTION OF EXAMPLE EMBODIMENTS

The following detailed description of example implementations refers to the accompanying drawings. The same reference numbers in different drawings may identify the same or similar elements.

A network data analytics function (NWDAF) is a component within core architectures of telecommunications networks. An NWDAF may collect, process, and analyze data from various network elements to provide actionable insights. These insights are utilized to enhance network performance, optimize resource allocation, and improve decision-making processes. An NWDAF may provide multiple machine learning models for a single analytics identifier to consumer network functions (NFs). This enables the consumer NFs to receive a variety of predictions for making more informed decisions within a network. However, the NWDAF may provide, to the consumer NFs, multiple machine learning models for predictions without clear guidance as to which machine learning model best fits a given scenario. Thus, current techniques for multipath communication within a 5G core network consume computing resources (e.g., processing resources, memory resources, communication resources, and/or the like), networking resources, and/or other resources associated with utilizing predictions from machine learning models that are inferior to predictions from other machine learning models, performing incorrect actions in the network based on the inferior predictions, handling network outages caused by performing the incorrect actions in the network, and/or the like.

Some implementations described herein provide best fit feedback for predictions from multiple machine learning models. For example, a device (e.g., an NWDAF) may receive, from a consumer NF, a prediction request that includes an analytics identifier and an indication of best fit feedback support by the consumer NF, and may generate multiple predictions for the analytics identifier using multiple machine learning models. The NWDAF may provide the multiple predictions to the consumer NF, and may receive, from the consumer NF, multiple best fit scores corresponding to the multiple predictions. The NWDAF may store the multiple best fit scores for the analytics identifier, and may update a selection process of the multiple machine learning models for future predictions based on the multiple best fit scores.

In this way, best fit feedback for predictions from multiple machine learning models may be provided. For example, an adaptive feedback loop may be provided between the NWDAF and consumer NFs, allowing for dynamic optimization of the consumer NFs through tailored machine learning model selection. By utilizing the best fit feedback, the NWDAF may iteratively refine predictive capabilities of the machine learning models. The NWDAF may optimize network resource allocation, may enhance accuracies of machine learning model predictions, and may improve overall network performance. The NWDAF may provide for more efficient use of the network's analytical capabilities, which may translate into reduced operational costs and increased network efficiency. Thus, the NWDAF may conserve computing resources, networking resources, and/or other resources that would have otherwise been consumed by utilizing predictions from machine learning models that are inferior to predictions from other machine learning models, performing incorrect actions in the network based on the inferior predictions, handling network outages caused by performing the incorrect actions in the network, and/or the like.

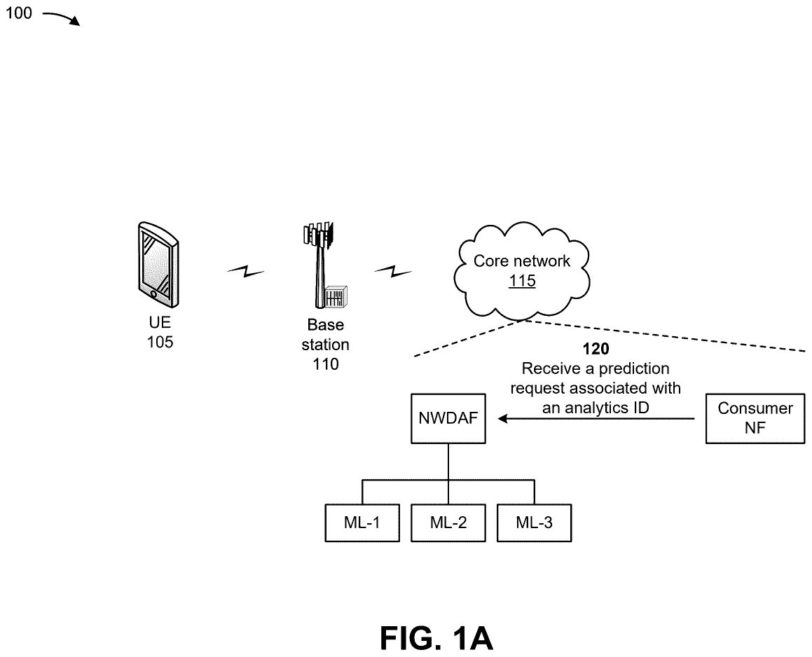

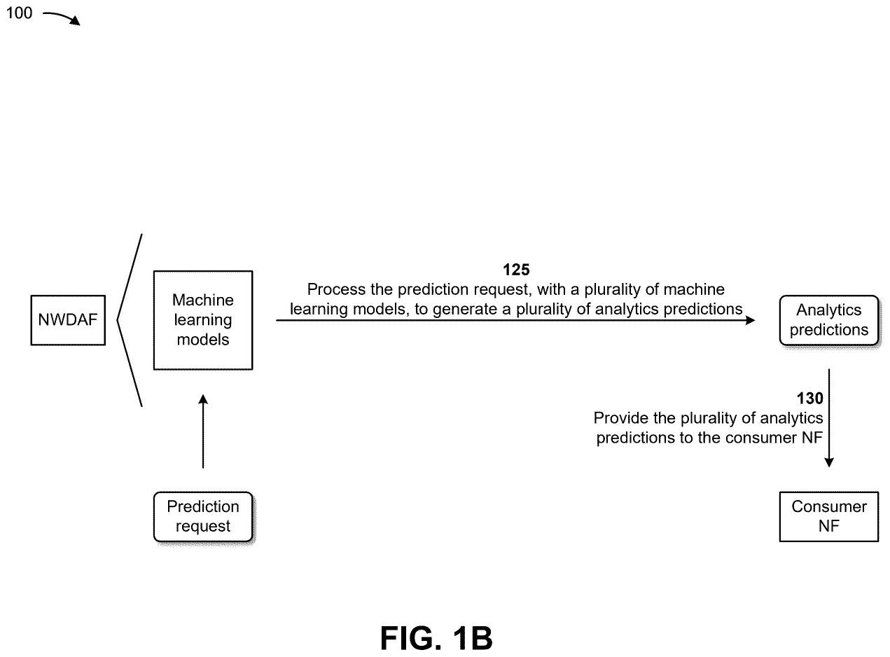

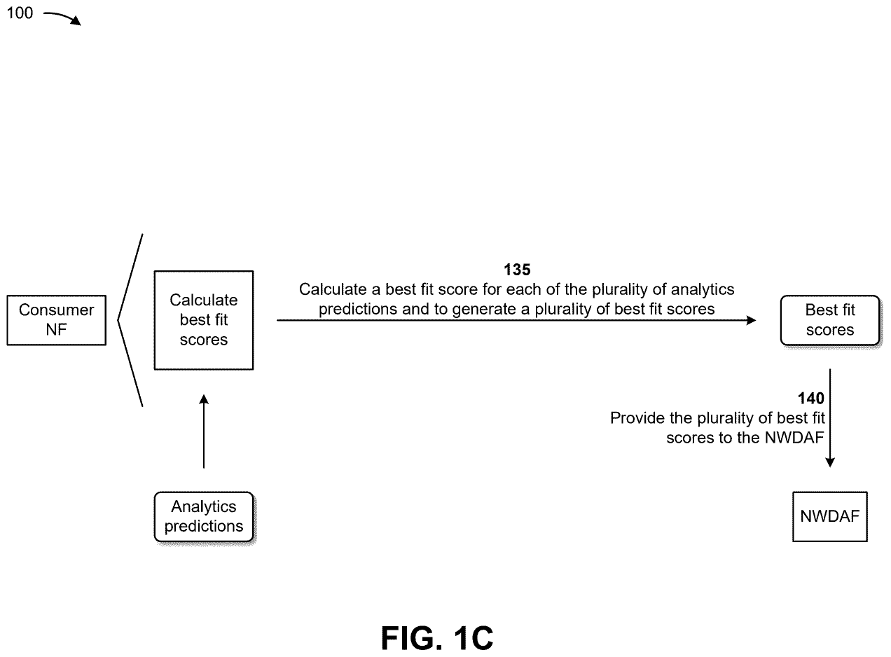

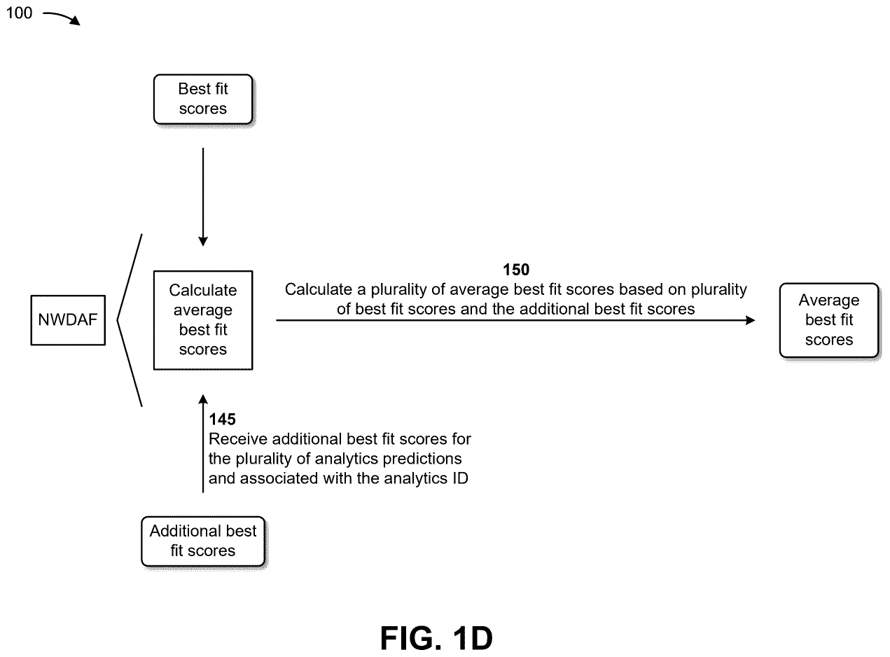

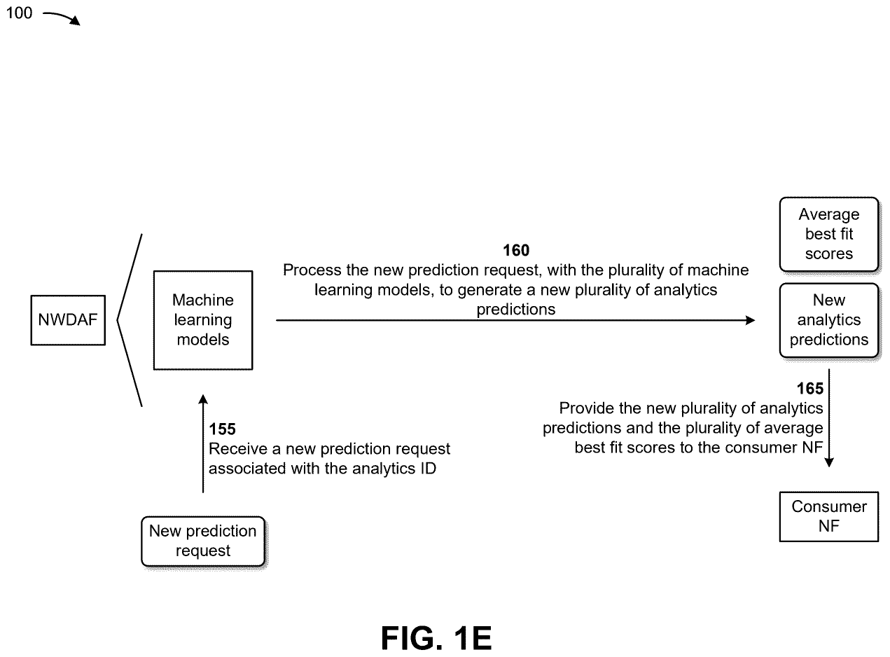

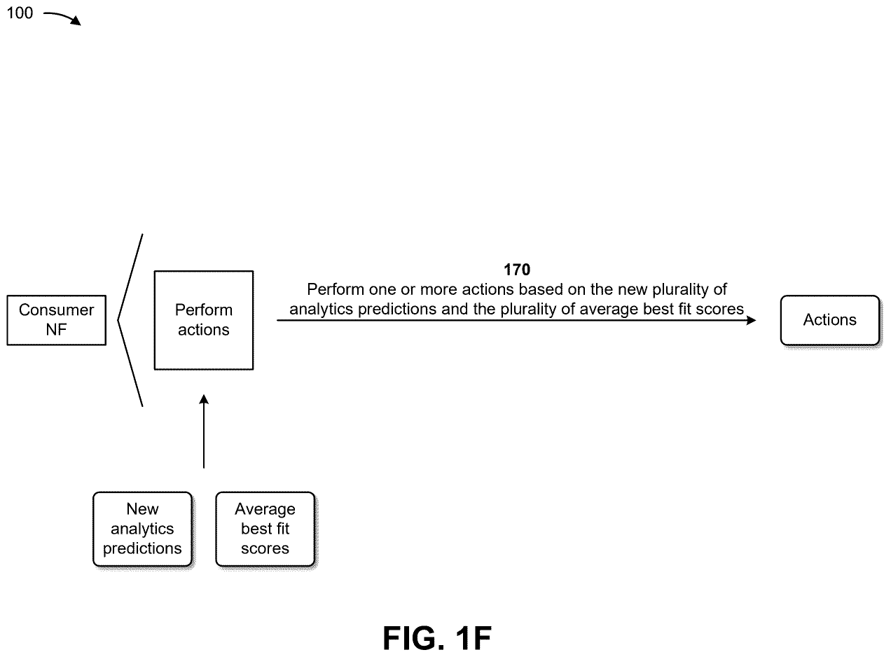

FIGS. 1A-1F are diagrams of an example 100 associated with providing best fit feedback for predictions from multiple machine learning models. As shown in FIGS. 1A-1F, example 100 includes a UE 105 associated with a base station 110, and a core network 115. The core network 115 may include a network data analytics function (NWDAF) and a consumer network function (NF) that is a consumer of predictions provided by machine learning models (e.g., ML-1, ML-2, and ML-3) provided by the NWDAF. Further details of the UE 105, the base station 110, the core network 115, the NWDAF, the consumer NF, and the machine learning models are provided elsewhere herein.

As shown in FIG. 1A, and by reference number 120, the NWDAF may receive a prediction request associated with an analytics identifier (ID). For example, the consumer NF may generate the prediction request associated with the analytics ID, and may provide the prediction request to the NWDAF. The NWDAF may receive the prediction request from the consumer NF. The prediction request may include the analytics ID and an indication of best fit feedback support by the consumer NF. The prediction request may cause the NWDAF to initiate a process of generating multiple predictions for the analytics ID using the multiple machine learning models. The analytics ID may be a unique identifier associated with a particular type of analysis or prediction requested by the consumer NF. The indication of best fit feedback support may indicate that the consumer NF is capable of providing feedback on which prediction of the machine learning models best fits the analytics ID.

As shown in FIG. 1B, and by reference number 125, the NWDAF may process the prediction request, with a plurality of machine learning models, to generate a plurality of analytics predictions. For example, the prediction request may be associated with the analytics ID that indicates the particular type of analysis or prediction requested by the consumer NF. The NWDAF may identify multiple machine learning models that perform the particular type of analysis or prediction indicated by the analytics ID. The NWDAF may utilize the identified multiple machine learning models to generate the plurality of analytics predictions. The plurality of analytics predictions may provide different perspectives or outcomes based on the different machine learning models utilized, thereby offering a comprehensive view to the consumer NF.

In one example, the NWDAF may identify a first machine learning model (ML-1), a second machine learning model (ML-2), and a third machine learning model (ML-3) as the machine learning models to utilize for the analytics ID included in the prediction request. The first machine learning model may generate a first prediction (e.g., prediction-1) for the analytics ID, the second machine learning model may generate a second prediction (e.g., prediction-2) for the analytics ID, and the third machine learning model may generate a third prediction (e.g., prediction-3) for the analytics ID. Thus, the NWDAF may generate prediction-1, prediction-2, and prediction-3 for the analytics ID.

As further shown in FIG. 1B, and by reference number 130, the NWDAF may provide the plurality of analytics predictions to the consumer NF. For example, the NWDAF may transmit the generated analytics predictions (e.g., prediction-1, prediction-2, and prediction-3) to the consumer NF. The plurality of analytics predictions may enable the consumer NF to evaluate the different analytics predictions and determine which analytics prediction is most suitable for a given scenario (e.g., a network maintenance scenario, a network throughput scenario, and/or the like). In some implementations, the consumer NF may perform one or more actions based on the determined analytics prediction and may monitor the remaining analytics predictions to provide best fit feedback to the NWDAF, as described elsewhere herein.

As shown in FIG. 1C, and by reference number 135, the consumer NF may calculate a best fit score for each of the plurality of analytics predictions and to generate a plurality of best fit scores. For example, the consumer NF may evaluate each of the analytics predictions received from the NWDAF, and may determine a best fit score that represents the accuracy or suitability of each analytics prediction. The best fit score may be based on various criteria, such as prediction relevance, accuracy, and timeliness. In one example, the best fit score may be provided on a scale of one to ten, with one being a lowest best fit score and ten being a highest best fit score. In some implementations, the best fit score may provide an indication of how well an analytics prediction aligns with actual outcomes. For example, the best fit score may enable the consumer NF to identify analytics predictions that are most pertinent to real-world scenarios. Additionally, or alternatively, the best fit scores may indicate a confidence level for each analytics prediction, assessing the analytics prediction likelihood of occurrence. Additionally, or alternatively, the consumer NF may calculate performance metrics for each analytics prediction, including precision, recall, and predictive performance scores (e.g., F-scores). The performance metrics may provide a comprehensive assessment of prediction quality. The consumer NF may utilize the performance metrics to calculate the plurality of best fit scores for the plurality of analytics predictions.

Additionally, or alternatively, the consumer NF may determine the best fit score for each analytics prediction by cross-referencing each analytics prediction with historical data to assess an accuracy of each analytics prediction. This may ensure that the analytics predictions are not only accurate but also consistent with past data. Additionally, or alternatively, the consumer NF may generate a compatibility index for each analytics prediction, reflecting how well each analytics prediction integrates with existing data models. The compatibility index may enable the consumer NF to determine the practical applicability of the analytics predictions in real-world scenarios. In some implementations, the consumer NF may utilize the compatibility indexes to calculate the plurality of best fit scores for the plurality of analytics predictions.

As further shown in FIG. 1C, and by reference number 140, the consumer NF may provide the plurality of best fit scores to the NWDAF. For example, the consumer NF may transmit the calculated best fit scores back to the NWDAF to enable the NWDAF to store and analyze the plurality of best fit scores. This best fit feedback loop may enable the NWDAF to learn which machine learning models generate the most accurate predictions for specific analytics identifiers and to refine a machine learning model selection process for future predictions. In some implementations, the consumer NF may provide the performance metrics, used to calculate the best fit scores, to the NWDAF. The performance metrics may enable the NWDAF to refine the machine learning models utilized to generate the analytics predictions. Additionally, or alternatively, the consumer NF may provide the compatibility index for each analytics prediction to the NWDAF. The compatibility indices may ensure that the NWDAF selects machine learning models that are best suited for the given data and context, enhancing overall prediction accuracy and relevance.

As shown in FIG. 1D, and by reference number 145, the NWDAF may receive additional best fit scores for the plurality of analytics predictions and associated with the analytics ID. In some implementations, the NWDAF may receive additional prediction requests associated with analytics IDs from the consumer NF and/or other consumer NFs. The NWDAF may generate additional analytics predictions for the additional prediction requests, and may provide the additional analytics predictions to the consumer NF and/or the other consumer NFs. The consumer NF and/or the other consumer NFs may generate additional best fit scores for the additional analytics predictions, and may provide the additional best fit scores to the NWDAF. The NWDAF may receive the additional best fit scores from the consumer NF and/or the other consumer NFs.

In some implementations, different consumer NFs may assess the analytics predictions based on specific use cases, providing a diverse range of feedback that can enhance overall machine learning model evaluation. Additionally, or alternatively, the additional best fit scores provided by the consumer NFs may include evaluations based on prediction accuracy, relevance, and timeliness. This varied feedback may enable the NWDAF to understand different dimensions of machine learning model performance, ensuring that the additional best fit scores capture comprehensive insights into the effectiveness of the additional analytics predictions. Additionally, or alternatively, the NWDAF may aggregate the additional best fit scores received from the various consumer NFs to form a comprehensive assessment of each machine learning model's performance. Aggregating feedback from multiple sources may provide for a more robust evaluation, making it possible to identify consistent strengths and weaknesses across different consumer NFs. Additionally, or alternatively, the additional best fit scores may be weighted based on an importance and a reliability of the consumer NF providing the additional best fit score. For example, an additional best fit score received from a highly reliable and critical consumer NF may be given more weight in the overall assessment to ensure that the most trusted evaluations influence machine learning model selection.

As further shown in FIG. 1D, and by reference number 150, the NWDAF may calculate a plurality of average best fit scores based on the plurality of best fit scores and the additional best fit scores. For example, the NWDAF may utilize statistical methods, such as time-series analysis, to calculate and update average best fit scores for each machine learning model based on the plurality of best fit scores and the additional best fit scores. Time-series analysis may enable the NWDAF to understand performance variations over specific intervals, thereby aiding in fine-tuning machine learning model selection. The calculation of the average best fit score may include statistical methods that ensure accurate representation of machine learning model performance. The NWDAF may utilize the average best fit scores to refine the machine learning model selection process for future predictions, ensuring that more accurate and contextually relevant machine learning models are prioritized.

In some implementations, the NWDAF may implement a feedback loop where consumer NFs continuously provide best fit scores, allowing for dynamic updates and improvements in the machine learning model selection. This may enable the NWDAF to adapt to evolving prediction needs in real-time. Additionally, or alternatively, the NWDAF may store historical best fit scores to track performance trends and make long-term adjustments to machine learning model selection criteria. By maintaining historical best fit scores, the NWDAF can analyze trend data to improve machine learning model accuracy over time. Additionally, or alternatively, best fit feedback scores may include qualitative data, such as user satisfaction or confidence levels, in addition to quantitative accuracy metrics. This qualitative information can provide context to the quantitative scores, offering a holistic view of machine learning model performance.

As shown in FIG. 1E, and by reference number 155, the NWDAF may receive a new prediction request associated with the analytics ID. For example, the consumer NF may generate the new prediction request associated with the analytics ID and may provide the new prediction request to the NWDAF. The new prediction request may include the analytics ID and may initiate the process of generating new predictions using multiple machine learning models. In some implementations, the NWDAF may receive a new prediction request that includes the analytics ID and the best fit feedback support indication. The indication of best fit feedback support may indicate that the consumer NF is capable of providing feedback on which prediction of the machine learning models best fits the analytics ID.

As further shown in FIG. 1E, and by reference number 160, the NWDAF may process the new prediction request, with the plurality of machine learning models, to generate a new plurality of analytics predictions. For example, the new prediction request may be associated with the analytics ID that indicates the particular type of analysis or prediction requested by the consumer NF. The NWDAF may identify multiple machine learning models that perform the particular type of analysis or prediction indicated by the analytics ID. The NWDAF may utilize the identified multiple machine learning models to generate the new plurality of analytics predictions. The new plurality of analytics predictions may provide different perspectives or outcomes based on the different machine learning models utilized, thereby offering a comprehensive view to the consumer NF.

As further shown in FIG. 1E, and by reference number 165, the NWDAF may provide the new plurality of analytics predictions and the plurality of average best fit scores to the consumer NF. For example, the NWDAF may identify the plurality of average best fit scores that correspond to the machine learning models that generated the new plurality of analytics predictions. The NWDAF may provide the identified plurality of average best fit scores, alone with the new plurality of analytics predictions, to the consumer NF. Each of the average best fit scores may represent a historical performance and accuracy of each machine learning model in generating analytics predictions for the specified analytics ID. The plurality of average best fit scores may enable the consumer NF to assess the quality of the new plurality of analytics predictions.

As shown in FIG. 1F, and by reference number 170, the consumer NF may perform one or more actions based on the new plurality of analytics predictions and the plurality of average best fit scores. For example, the consumer NF may evaluate the new analytics predictions received from the NWDAF, along with the average best fit scores, which represent historical performance and accuracy of each machine learning model utilized by the NWDAF. Based on this evaluation, the consumer NF may determine a most suitable prediction to act upon, ensuring that actions taken are informed by both recent predictions and historical model performance data. In some implementations, the consumer NF may prioritize actions on analytics predictions with higher average best fit scores, indicating greater reliability and relevance. For example, the consumer NF may initiate network optimization processes, adjust resource allocations, or implement other network management actions based on the analytics prediction deemed most accurate. Additionally, the consumer NF may monitor outcomes of the actions and may provide further feedback to the NWDAF to refine future analytics predictions. This feedback loop may ensure the continuous improvement of the machine learning models and may enhance the overall efficiency and performance of the network.

In some implementations, the consumer NF may initiate one or more network functions based on the new analytics predictions and the associated average best fit scores. For example, the consumer NF may select the most accurate analytics prediction to optimize network traffic flow. Additionally, or alternatively, the consumer NF may adjust resource management strategies based on the new analytics predictions and corresponding average best fit scores. For example, the consumer NF may modify bandwidth allocation in response to the most reliable analytics prediction. Additionally, or alternatively, the consumer NF may implement operational changes based on the new analytics predictions and their corresponding average best fit scores. For example, the consumer NF may prioritize system updates and maintenance activities based on the highest-scoring analytics prediction.

Additionally, or alternatively, the consumer NF may execute one or more procedures based on the new analytics predictions and the average best fit scores. For example, the consumer NF may enhance network security protocols based on the most dependable analytics prediction. Additionally, or alternatively, the consumer NF may perform adaptive measures based on the new analytics predictions and the average best fit scores. For example, the consumer NF may dynamically adjust service levels to meet predicted demand spikes. Additionally, or alternatively, the consumer NF may engage in predictive maintenance activities based on the new analytics predictions and the average best fit scores. For example, the consumer NF may schedule preventative maintenance for network equipment based on the most accurate prediction. Additionally, or alternatively, the consumer NF may optimize network configurations based on the new analytics predictions and the average best fit scores. For example, the consumer NF may reconfigure network settings to enhance performance based on the highest average best fit score.

Additionally, or alternatively, the consumer NF may conduct further analysis and reporting based on the new analytics predictions and the average best fit scores. For example, the consumer NF may generate reports on network performance trends informed by the most accurate analytics predictions. Additionally, or alternatively, the consumer NF may adapt a machine learning model selection process based on the average best fit scores and the new analytics predictions. For example, the consumer NF may prioritize machine learning models with consistently high average best fit scores for future predictions. Additionally, or alternatively, the consumer NF may provide continuous feedback to the NWDAF based on the outcomes of actions taken in response to the new analytics predictions and average best fit scores. For example, the feedback may include performance metrics that help refine the accuracy of future predictions.

In this way, best fit feedback for predictions from multiple machine learning models may be provided. For example, an adaptive feedback loop may be provided between the NWDAF and consumer NFs, allowing for dynamic optimization of the consumer NFs through tailored machine learning model selection. By utilizing the best fit feedback, the NWDAF may iteratively refine predictive capabilities of the machine learning models. The NWDAF may optimize network resource allocation, may enhance accuracies of machine learning model predictions, and may improve overall network performance. The NWDAF may provide for more efficient use of the network's analytical capabilities, which may translate into reduced operational costs and increased network efficiency. Thus, the NWDAF may conserve computing resources, networking resources, and/or other resources that would have otherwise been consumed by utilizing predictions from machine learning models that are inferior to predictions from other machine learning models, performing incorrect actions in the network based on the inferior predictions, handling network outages caused by performing the incorrect actions in the network, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

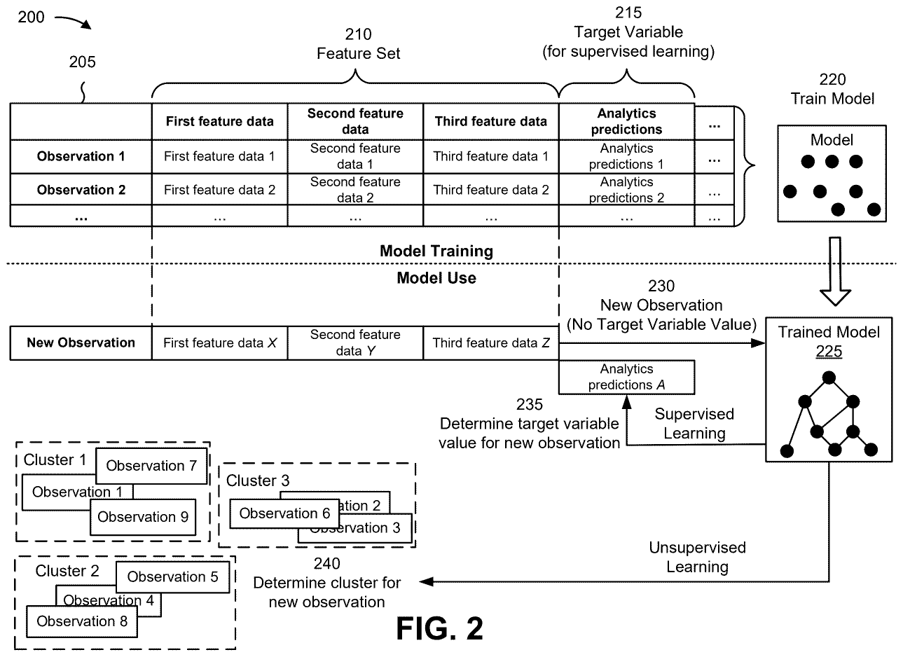

FIG. 2 is a diagram illustrating an example 200 of training and using a machine learning model for generating analytics predictions. The machine learning model training and usage described herein may be performed using a machine learning system. The machine learning system may include or may be included in a computing device, a server, a cloud computing environment, and/or the like, such as the NWDAF described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the NWDAF, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the NWDAF. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of first feature data, a second feature of second feature data, a third feature of third feature data, and so on. As shown, for a first observation, the first feature may have a value of first feature data 1, the second feature may have a value of second feature data 1, the third feature may have a value of third features data 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “Analytics predictions” and may include a value of analytics predictions 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of first feature data X, a second feature of second feature data Y, a third feature of third feature data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of analytics predictions A for the target variable of the analytics predictions for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first feature data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second feature data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to generate analytics predictions. The machine learning system enables recognition and/or identification of tens, hundreds, thousands, or millions of features and/or feature values for tens, hundreds, thousands, or millions of observations, thereby increasing accuracy and consistency and reducing delay associated with generating analytics predictions relative to requiring computing resources to be allocated for tens, hundreds, or thousands of operators to manually generate analytics predictions.

As indicated above, FIG. 2 is provided as an example. Other examples may differ from what is described in connection with FIG. 2.

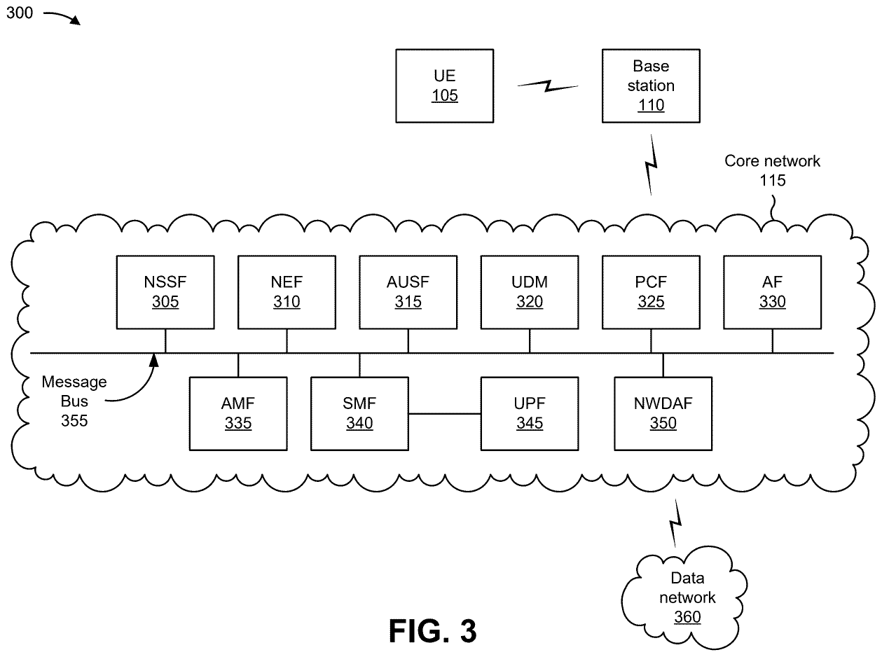

FIG. 3 is a diagram of an example environment 300 in which systems and/or methods described herein may be implemented. As shown in FIG. 3, the example environment 300 may include the UE 105, a base station 110, the core network 115, and a data network 360. Devices and/or networks of the example environment 300 may interconnect via wired connections, wireless connections, or a combination of wired and wireless connections.

The UE 105 includes one or more devices capable of receiving, generating, storing, processing, and/or providing information, such as information described herein. For example, the UE 105 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 110 may support, for example, a cellular radio access technology (RAT). The base station 110 may include one or more base stations (e.g., base transceiver stations, radio base stations, node Bs, eNodeBs (eNBs) (e.g., the 4G base station 110), gNodeBs (gNBs) (e.g., the 5G base stations 110-1 and 110-2), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The base station 110 may transfer traffic between the UE 105 (e.g., using a cellular RAT), one or more base stations (e.g., using a wireless interface or a backhaul interface, such as a wired backhaul interface), and/or the core network 115. The base station 110 may provide one or more cells that cover geographic areas.

In some implementations, the base station 110 may perform scheduling and/or resource management for the UE 105 covered by the base station 110 (e.g., the UE 105 covered by a cell provided by the base station 110). In some implementations, the base station 110 may be controlled or coordinated by a network controller, which may perform load balancing, network-level configuration, and/or other operations. The network controller may communicate with the base station 110 via a wireless or wireline backhaul. In some implementations, the base station 110 may include a network controller, a self-organizing network (SON) module or component, or a similar module or component. In other words, the base station 110 may perform network control, scheduling, and/or network management functions (e.g., for uplink, downlink, and/or sidelink communications of the UE 105 covered by the base station 110).

In some implementations, the core network 115 may include an example functional architecture in which systems and/or methods described herein may be implemented. For example, the core network 115 may include an example architecture of a fifth generation (5G) next generation (NG) core network included in a 5G wireless telecommunications system. While the example architecture of the core network 115 shown in FIG. 3 may be an example of a service-based architecture, in some implementations, the core network 115 may be implemented as a reference-point architecture and/or a 4G core network, among other examples.

As shown in FIG. 3, the core network 115 may include a number of functional elements. The functional elements may include, for example, a network slice selection function (NSSF) 305, a network exposure function (NEF) 310, an authentication server function (AUSF) 315, a unified data management (UDM) component 320, a policy control function (PCF) 325, an application function (AF) 330, an access and mobility management function (AMF) 335, a session management function (SMF) 340, a user plane function (UPF) 345, and/or an NWDAF 350. These functional elements may be communicatively connected via a message bus 355. In some implementations, each of the NSSF 305, the NEF 310, the AUSF 315, the UDM 320, the PCF 325, the AF 330, the AMF 335, the SMF 340, the UPF 345 may be a consumer NF of predictions provided by machine learning models of the NWDAF 350. Each of the functional elements shown in FIG. 3 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 305 includes one or more devices that select network slice instances for the UE 105. By providing network slicing, the NSSF 305 allows an operator to deploy multiple substantially independent end-to-end networks potentially with the same infrastructure. In some implementations, each slice may be customized for different services.

The NEF 310 includes one or more devices that support exposure of capabilities and/or events in the wireless telecommunications system to help other entities in the wireless telecommunications system discover network services.

The AUSF 315 includes one or more devices that act as an authentication server and support the process of authenticating the UE 105 in the wireless telecommunications system.

The UDM 320 includes one or more devices that store user data and profiles in the wireless telecommunications system. The UDM 320 may be used for fixed access and/or mobile access in the core network 115.

The PCF 325 includes one or more devices that provide a policy framework that incorporates network slicing, roaming, packet processing, and/or mobility management, among other examples.

The AF 330 includes one or more devices that support application influence on traffic routing, access to the NEF 310, and/or policy control, among other examples.

The AMF 335 includes one or more devices that act as a termination point for non-access stratum (NAS) signaling and/or mobility management, among other examples.

The SMF 340 includes one or more devices that support the establishment, modification, and release of communication sessions in the wireless telecommunications system. For example, the SMF 340 may configure traffic steering policies at the UPF 345 and/or may enforce user equipment Internet protocol (IP) address allocation and policies, among other examples.

The UPF 345 includes one or more devices that serve as an anchor point for intraRAT and/or interRAT mobility. The UPF 345 may apply rules to packets, such as rules pertaining to packet routing, traffic reporting, and/or handling user plane quality of service (QoS), among other examples.

The NWDAF 350 includes one or more devices that enable advanced data analytics within the core network 115. The NWDAF 350 collects, processes, and analyzes data from various network elements to provide valuable insights that can help improve the efficiency, performance, and management of the core network 115. The NWDAF 350 may gather data from multiple sources within the core network 115, such as the AMF 335, the SMF 340, the UPF 345, and/or the like. The NWDAF 350 may utilize and other analytical tools with the collected data to identify trends, detect anomalies, and predict future network conditions. The NWDAF 350 may provide reports and analytics outputs to various network entities, such as the PCF 325, the AF 330, an operations and management (OAM) system, and/or the like.

The message bus 355 represents a communication structure for communication among the functional elements. In other words, the message bus 355 may permit communication between two or more functional elements.

The data network 360 includes one or more wired and/or wireless data networks. For example, the data network 360 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the example environment 300 may perform one or more functions described as being performed by another set of devices of the example environment 300.

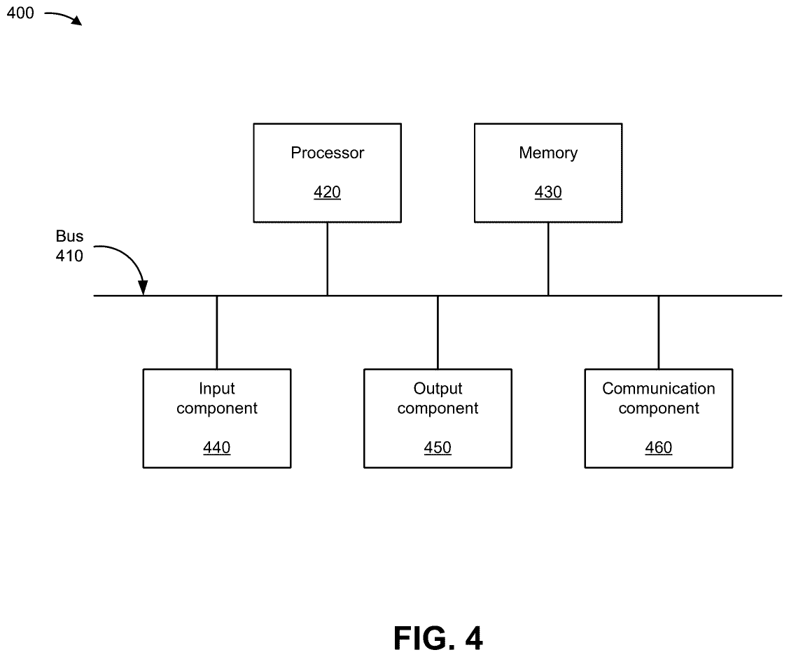

FIG. 4 is a diagram of example components of a device 400, which may correspond to the UE 105, the base station 110, the NSSF 305, the NEF 310, the AUSF 315, the UDM 320, the PCF 325, the AF 330, the AMF 335, the SMF 340, the UPF 345, and/or the NWDAF 350. In some implementations, the UE 105, the base station 110, the NSSF 305, the NEF 310, the AUSF 315, the UDM 320, the PCF 325, the AF 330, the AMF 335, the SMF 340, the UPF 345, and/or the NWDAF 350 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

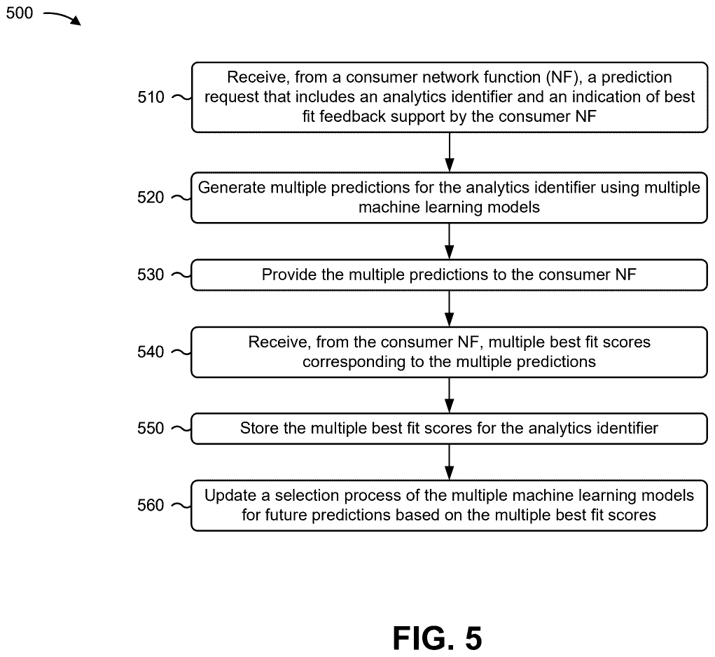

FIG. 5 is a flowchart of an example process 500 for providing best fit feedback for predictions from multiple machine learning models. In some implementations, one or more process blocks of FIG. 5 may be performed by a device (e.g., a network device of the core network, such as the NWDAF 350). In some implementations, one or more process blocks of FIG. 5 may be performed by another device or a group of devices separate from or including the device, such as another network device (e.g., the NSSF 305, the NEF 310, the AUSF 315, and/or the like) of the core network 115. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving, from a consumer NF, a prediction request that includes an analytics identifier and an indication of best fit feedback support by the consumer NF (block 510). For example, the device may receive, from a consumer NF, a prediction request that includes an analytics identifier and an indication of best fit feedback support by the consumer NF, as described above. In some implementations, the prediction request is received via a subscription message. In some implementations, the device is an NWDAF.

As further shown in FIG. 5, process 500 may include generating multiple predictions for the analytics identifier using multiple machine learning models (block 520). For example, the device may generate multiple predictions for the analytics identifier using multiple machine learning models, as described above. In some implementations, each of the multiple predictions includes a timestamp. In some implementations, the multiple predictions include analytics predictions associated with a core network.

As further shown in FIG. 5, process 500 may include providing the multiple predictions to the consumer NF (block 530). For example, the device may provide the multiple predictions to the consumer NF, as described above.

As further shown in FIG. 5, process 500 may include receiving, from the consumer NF, multiple best fit scores corresponding to the multiple predictions (block 540). For example, the device may receive, from the consumer NF, multiple best fit scores corresponding to the multiple predictions, as described above. In some implementations, each of the multiple predictions generated by the multiple machine learning models is associated with one of the multiple best fit scores, and each of the best fit scores represents an accuracy of a respective one of the multiple predictions. In some implementations, the consumer NF is configured to perform one or more actions based on the multiple predictions and the multiple best fit scores.

As further shown in FIG. 5, process 500 may include storing the multiple best fit scores for the analytics identifier (block 550). For example, the device may store the multiple best fit scores for the analytics identifier, as described above. In some implementations, the device stores the multiple best fit scores in association with respective machine learning models and the analytics identifier in a data repository.

As further shown in FIG. 5, process 500 may include updating a selection process of the multiple machine learning models for future predictions based on the multiple best fit scores (block 560). For example, the device may update a selection process of the multiple machine learning models for future predictions based on the multiple best fit scores, as described above. In some implementations, updating the selection process of the multiple machine learning models includes assigning a higher priority to machine learning models associated with higher average best fit scores.

In some implementations, process 500 includes calculating average best fit scores for the multiple machine learning models based on the multiple best fit scores over a period of time. In some implementations, process 500 includes providing the multiple best fit scores to other consumer NFs in response to future prediction requests. In some implementations, process 500 includes configuring the best fit feedback support for the consumer NF based on a configuration parameter received from the consumer NF. In some implementations, process 500 includes retraining the multiple machine learning models based on the multiple best fit scores.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device and from a consumer network function (NF), a prediction request that includes an analytics identifier and an indication of best fit feedback support by the consumer NF;
generating, by the device, multiple predictions for the analytics identifier using multiple machine learning models;
providing, by the device, the multiple predictions to the consumer NF;
receiving, by the device and from the consumer NF, multiple best fit scores corresponding to the multiple predictions;
storing, by the device, the multiple best fit scores for the analytics identifier; and
updating, by the device, a selection process of the multiple machine learning models for future predictions based on the multiple best fit scores.

2. The method of claim 1, wherein each of the multiple predictions generated by the multiple machine learning models is associated with one of the multiple best fit scores, and each of the multiple best fit scores represents an accuracy of a respective one of the multiple predictions.

3. The method of claim 1, further comprising:
calculating average best fit scores for the multiple machine learning models based on the multiple best fit scores over a period of time.

4. The method of claim 3, wherein updating the selection process of the multiple machine learning models comprises:
assigning a higher priority to machine learning models associated with higher average best fit scores.

5. The method of claim 1, wherein each of the multiple predictions includes a timestamp.

6. The method of claim 1, wherein the consumer NF is configured to perform one or more actions based on the multiple predictions and the multiple best fit scores.

7. The method of claim 1, further comprising:
providing the multiple best fit scores to other consumer NFs in response to future prediction requests.

8. A device, comprising:
one or more processors configured to:
receive, from a consumer network function (NF), a prediction request that includes an analytics identifier and an indication of best fit feedback support by the consumer NF;
generate multiple predictions for the analytics identifier using multiple machine learning models;
provide the multiple predictions to the consumer NF;
receive, from the consumer NF, multiple best fit scores corresponding to the multiple predictions,
wherein each of the multiple best fit scores represents an accuracy of a respective one of the multiple predictions;
store the multiple best fit scores for the analytics identifier; and
update a selection process of the multiple machine learning models for future predictions based on the multiple best fit scores.

9. The device of claim 8, wherein the one or more processors are further configured to: configure the best fit feedback support for the consumer NF based on a configuration parameter received from the consumer NF.

10. The device of claim 8, wherein the prediction request is received via a subscription message.

11. The device of claim 8, wherein the device stores the multiple best fit scores in association with respective machine learning models and the analytics identifier in a data repository.

12. The device of claim 8, wherein the one or more processors are further configured to:
retrain the multiple machine learning models based on the multiple best fit scores.

13. The device of claim 8, wherein the multiple predictions include analytics predictions associated with a core network.

14. The device of claim 8, wherein the device is a network data analytics function.

15. A non-transitory computer-readable medium storing a set of instructions, the set of instructions comprising:
one or more instructions that, when executed by one or more processors of a device, cause the device to:
receive, from a consumer network function (NF), a prediction request that includes an analytics identifier and an indication of best fit feedback support by the consumer NF;
generate multiple predictions for the analytics identifier using multiple machine learning models,
wherein the multiple predictions include analytics predictions associated with a core network;
provide the multiple predictions to the consumer NF;
receive, from the consumer NF, multiple best fit scores corresponding to the multiple predictions;
store the multiple best fit scores for the analytics identifier; and
update a selection process of the multiple machine learning models for future predictions based on the multiple best fit scores.

16. The non-transitory computer-readable medium of claim 15, wherein the one or more instructions further cause the device to:
calculate average best fit scores for the multiple machine learning models based on the multiple best fit scores over a period of time; and
assign a higher priority to machine learning models associated with higher average best fit scores.

17. The non-transitory computer-readable medium of claim 15, wherein the one or more instructions further cause the device to:
provide the multiple best fit scores to other consumer NFs in response to future prediction requests.

18. The non-transitory computer-readable medium of claim 15, wherein the one or more instructions further cause the device to:
configure the best fit feedback support for the consumer NF based on a configuration parameter received from the consumer NF.

19. The non-transitory computer-readable medium of claim 15, wherein the device stores the multiple best fit scores in association with respective machine learning models and the analytics identifier in a data repository.

20. The non-transitory computer-readable medium of claim 15, wherein the one or more instructions further cause the device to:
retrain the multiple machine learning models based on the multiple best fit scores.
